(19) United States
(12) Patent Application Publication
(10) Pub. No.: US 2023/0281517 A1
(43) Pub. Date: Sep. 7, 2023

(54) EFFICIENT, SECURE AND LOW-COMMUNICATION VERTICAL FEDERATED LEARNING METHOD

(71) Applicant: ZHEJIANG UNIVERSITY, Hangzhou (CN)

(72) Inventors: Jian LIU, Hangzhou (CN); Zhihua TIAN, Hangzhou (CN); Kui REN, Hangzhou (CN)

(21) Appl. No.: 18/316,256

(22) Filed: May 12, 2023

Related U.S. Application Data
(63) Continuation of application No. PCT/CN2022/074421, filed on Jan. 27, 2022.

(30) Foreign Application Priority Data
Nov. 16, 2021 (CN) 202111356723.1

(51) Int. Cl. G06N 20/00

(52) U.S. Cl. CPC G06N 20/00

(57) ABSTRACT

An efficient, secure and low-communication vertical federated learning method, includes: all participants select part of features of a held data feature set and a small number of samples of the selected features; the participants add noise satisfying differential privacy to part of samples of the selected features, and then send them to other participants together with data indexes of the selected samples; all participants take the received feature data as a label, take each missing feature as a learning task, and train each model with the feature data originally held in the same data index, respectively; all participants predict the data of the other samples with the trained model to complete the missing feature; the participants jointly train a model through horizontal federated learning. The present disclosure can protect data privacy and provide quantitative support for data privacy protection while efficiently training the model with horizontal federated learning.

### CROSS-REFERENCE TO RELATED APPLICATIONS

The present application is a continuation of International Application No. PCT/CN2022/074421, filed on Jan. 27, 2022, which claims priority to Chinese Patent Application No. 202111356723.1, field on Nov. 16, 2021, the content of which are incorporated herein by reference in their entireties.

### TECHNICAL FIELD

The present disclosure relates to the technical field of federated learning, in particular to an efficient, secure and low-communication vertical federated learning method.

### BACKGROUND

Federated learning is a machine learning technology proposed by Google to jointly train models on distributed devices or servers with data stored. Compared with traditional centralized learning, federated learning does not need to gather data together, in such a way that the transmission cost among devices are reduced and the privacy of data is protected to a great extent.

Federated learning has been significantly developed since being proposed. Especially, with the more and more extensive application of distributed scenes, federated learning applications have attracted more and more attention. According to different data division manners, federated learning is mainly divided into two types, horizontal federated learning and vertical federated learning. In the horizontal federated learning, the data distributed in different devices have the same features, but belong to different users. In the vertical federated learning, the data distributed in different devices belong to the same user, but have different features. The two federated learning paradigms have completely different training mechanisms, and are thereby separately discussed in most of the current studies. Therefore, horizontal federated learning has made great progress, and yet vertical federated leaning has some problems such as low security and inefficiency that need to be solved.

Nowadays, with the arrival of the big data era, companies can readily obtain enormous data sets, but it is difficult to obtain data with different features. Therefore, vertical federated learning has drawn more and more attention in industry. Due to the advantages of horizontal federated learning, in case, with the aid of horizontal federated learning in the vertical federation learning process, a more efficient and secure vertical federated learning mechanism can be developed easier.

### SUMMARY

The present disclosure aims to provide an efficient, secure and low-communication vertical federated learning method. A model is trained to complete feature data of each participant in the case that the participants contain different feature data (including the case that only one participant holds a label). Then horizontal federated learning is used to jointly train the model with the data held by each participant, so as to solve the problems such as security efficiency and traffic load in the vertical federated learning process. At the cost of minimal loss of accuracy, the training can be completed more efficiently and quickly.

The purpose of the present disclosure is implemented through the following technical solution:
An efficient, secure and low-communication vertical federated learning method, including the following steps:
(1) All participants select part of features of a held data feature set, then add noise satisfying differential privacy to part of samples of the selected features, and send the part of samples to other participants together with data indexes of the selected samples. The held data feature set comprises feature data and label data. The label data is regarded as a feature to participate in the feature data completion process, and when multiple participants (not all) or only one participant holds a label, the label data is also regarded as a missing feature, model training and prediction are carried out and the labels of all participants are completed.
(2) All participants align the data according to the data indexes, take the received feature data as a label, take each missing feature as a learning task, and train multiple models with the feature data originally held in the same data index, respectively.
(3) All participants predict the data corresponding to other data indexes with multiple models trained in the step (2) to complete the missing feature.
(4) All participants work together with horizontal federated learning method to obtain a final trained model.

Further, when all participants hold the label data, the held data feature set only consists of the feature data.

Further, the data feature set is personal privacy information in the step (1). In a sense of vertical federated learning, sending index data will not lead to the disclosure of additional information.

Further, in the step (1), each participant uses the BlinkML method to determine an optimal sample number of each selected feature sent to each of the other participants, and then adds noise satisfying differential privacy to part of the samples of each selected feature according to the determined optimal sample number, and sends the part of samples together with the data indexes of the selected samples to other corresponding participants. In the method, only a few samples is needed to be sent to each other in advance to determine the optimal (least) sample number to be sent.

Further, each participant uses the BlinkML method to determine the optimal sample number of each selected feature sent to each of the other participant, including the following steps:
(a) Selecting no sample data by each participant uniformly and randomly, adding differential privacy noise, and then sending the part of samples together with the data indexes of the selected samples to the other participants for each selected feature i.
(b) Aligning the data by the participant j receiving the data according to the data indexes, taking the received feature data i as a label, and using feature data originally held in the same data index to train and obtain a model M_{i,j}.
(c) Constructing a matrix Q. Each row of Q includes no parameter gradients obtained by updating a model parameter θ_{i,j} of M_{i,j} of each sample.
(d) Calculating L=UA, where U is a matrix of size n₀×n₀ after singular value decomposition of matrix Q, Λ is a diagonal matrix, of which the value of the r^{th} element on the diagonal is sᵣ/(sᵣ²+β), sᵣ is the r^{th} singular value in Σ, β is a regularization coefficient, which can be 0.001, and Σ is a singular value matrix of matrix Q.
(e) Obtaining [symbol] by sampling from a normal distribution

$$N ( {θ}_{i , j} , {α}_{1} L {L}^{T} ) ,$$

and then obtaining θ_{i,j,N,k} by sampling from a normal distribution N ( [symbol] α₂LL^{T}). Repeating for K times to obtain K pairs ( [symbol] θ_{i,j,N,k}) where k represents a sample number.

$${α}_{1} = \sqrt{\frac{1}{{n}_{0}} - \frac{1}{}} , {α}_{2} = \sqrt{\frac{1}{} - \frac{1}{N}} , = \frac{1}{2} ( {n}_{0} + N ) ,$$

represents the candidate sample number of the i^{th} feature sent to the participant j. N is the total number of the samples for each participant.

$$( f ) Calculating p = \frac{1}{K} {\sum }_{k = 1}^{K} 1 [ {E}_{x ∈ D} ( 1 [ {M}_{i , j} ( x ; ) \neq {M}_{i , j} ( x ; {θ}_{i , j , N , k} ) ] ) < ϵ ] ,$$

where M(x; [symbol] )represents that the participant j takes the feature data held by the sample x as the input, [symbol] is a model parameter, the output of the model M_{i,j} is a predicted feature data i, D is a sample set, E(*) is an excepted value, and ∈ is a real number that represents a threshold.

If p>1−δ, letting

$$= \frac{1}{2} ( {n}_{i , j , 0} + ) ,$$

and if p<1−δ, letting

$$= \frac{1}{2} ( N + ) ,$$

where δ represents a threshold, which is a real number. Carrying out the process according to the step (e) and the step (f) for multiple times until an optimal candidate sample number [symbol] that should be selected for each feature is obtained through convergence.
(g) The number of samples randomly selected by the each participant to a participant j of feature i is [symbol] .

Further, if each participant has a missing feature which does not receive data in the step (2), the model of the missing feature without receiving data is obtained with the method of labeled-unlabeled multitask learning (A. Pentina and C. H. Lampert, “Multi-task learning with labeled and unlabeled tasks,” in Proceedings of the 34th International Conference on Machine Learning-Volume 70, ser. ICML'17. JMLR.org, 2017, p. 2807-2816), including the following steps:
(a) Dividing existing data of the participant into m data sets S, which corresponds to training data of each missing feature, respectively, where m is the number of the missing features of participants, and I is a set of labeled tasks in the missing features.
(b) Calculating a difference between the data sets according to the training data: disc(Sₚ,S_{q}),p,q∈{1, . . . , m}, p≠q, where disc(Sₚ,Sₚ)=0.
(c) For each unlabeled task, minimizing

$$\frac{1}{m} {\sum }_{q = 1}^{m} {\sum }_{p ∈ I} {σ}_{p} disc ( {S}_{q} , {S}_{p} )$$

and obtaining a weight σ^{T}={σ₁, . . . , σₘ}, where Σₚ₌₁^{m} σₚ=1.
(d) Obtaining the model M_{T} of each unlabeled task by minimizing a convex combination of training errors of labeled tasks, where T∈{1, . . . , m}/I:

$${{σ}^{T}}_{} ( {M}_{T} ) = {\sum }_{p ∈ I} {σ}_{p} {p}_{} ( {M}_{T} )$$

$${p}_{} ( {M}_{T} ) = \frac{1}{{n}_{{s}_{p}}} {\sum }_{( x , y ) ∈ {S}_{p} , p ∈ I} L ( {M}_{T} ( x ) , y ) .$$

L(*) is a loss function of a model in which a sample of a data set Sₚ is taken as an input, where nₛ_{ₚ} represents a sample number of a data set Sₚ, x is a sample feature of the input, and y is a label.

Further, all participants jointly train a model by using horizontal federated learning, which is not limited to a specific method.

Compared with the prior art, the present disclosure has the following advantages: the present disclosure combines vertical federated learning with horizontal federated learning, and provides a new idea for the development of vertical federated learning by transforming vertical federated learning into horizontal federated learning. By applying the differential privacy to the method according to the present disclosure, data privacy is guaranteed, and thereby data security is theoretically guaranteed. Combined with the method of multitask learning, the traffic load of the data is significantly reduced, and the training time is thereby reduced. The efficient, secure and low-communication vertical federated learning method according to the present disclosure has the advantages of simple use and high training efficiency, and can be implemented in industrial sense while protecting data privacy.

### BRIEF DESCRIPTION OF DRAWINGS

FIG. 1 is a flowchart of vertical federated learning according to the present disclosure.

### DESCRIPTION OF EMBODIMENTS

The arrival of the Internet era provides conditions for the collection of big data, however, with the gradual exposure of data security problems and the protection of data privacy by enterprises, the problem of data “island” is becoming more and more serious. At the same time, although enterprises have a large amount of data due to the development of Internet technology, the user feature of the data are different due to business restrictions and other reasons. If the data is used, a model with higher accuracy and stronger generalization ability can be trained. Therefore, it has become one of the methods to solve the problem by sharing data among enterprises, breaking the data “island”, as well as protecting data privacy.

The present disclosure aims at the above scene. That is, under the premise that the data is stored in local, a model is jointly trained with multiple data to protect the data privacy of all participants and the training efficiency is improved while controlling the loss of accuracy.

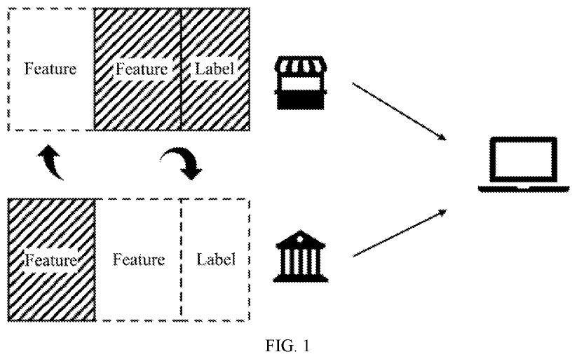

FIG. 1 is a flowchart of an efficient, secure and low-communication vertical federated learning method according to the present disclosure. The data feature set adopted in the present disclosure is personal privacy information. In an embodiment, the method includes the following steps:
(1) All participants select some features of a held data feature set and a small number of samples of the selected features. The feature selection method is random selection, and the sample selection method is preferably the BlinkML method, including the following steps:
(a) Each participant selects no sample data uniformly and randomly for each selected feature I, then adds differential privacy noise and send them to the other participants together with data indexes of the selected samples, where no is minimal and preferably a positive integer in the range of 1−1%×N, N is the total number of the samples.
(b) The participant j receiving the data aligns the data according to the data indexes, and takes the received feature data i as a label, and uses the feature data originally held in the same data index to train and obtain a model M_{i,j}. The size of model parameters matrix θ_{i,j} of the model M_{i,j} is 1×d_{i,j}, and d_{i,j} is the number of the model parameter.
(c) A matrix Q (with a size of n₀×d_{i,j}) is constructed with n₀ samples and θ_{i,j}. Each row of Q represents a parameter gradient obtained by updating θ_{i,j} of each sample.
(d) Matrix decomposition Q^{T}=UΣV^{T} is used to obtain Σ. Σ is a non-negative diagonal matrix, U and V satisfy Q_{T}Q=U, respectively, where V^{T}V=I, and I is an identity matrix. Then a diagonal matrix Λ is constructed, of which the value of the r^{th} element on the diagonal is sᵣ/(sᵣ²+β), where sᵣ is the r^{th} singular value in Σ, and β is the regularization coefficient, which can be 0.001. Calculating L=UΛ.
(e) The following process is repeated for K times to obtain K pairs

$$( {θ}_{i , j , , k} , {θ}_{i , j , N , k} ) ,$$

where

$${θ}_{i , j , , k}$$

and θ_{i,j,N,k} represent the model parameters obtained from the kₜₕ sampling by training with [symbol] or N samples, respectively, [symbol] represents the optimal candidate sample number of the i^{th} feature sent to the participant j.
a) Obtaining

$${θ}_{i , j , , k}$$

by sampling from a normal distribution

$$N ( {θ}_{i , j} , {α}_{1} L {L}^{T} ) ,$$

where

$${α}_{1} = \sqrt{\frac{1}{{n}_{0}} - \frac{1}{\tilde{{n}_{i , j , 0}}}} .$$

b) Obtaining θ_{i,j,N,k} by sampling from a normal distribution

$$N ( {θ}_{i , j , , k} , {α}_{2} {LL}^{T} ) ,$$

where

$${α}_{2} = \sqrt{\frac{1}{} - \frac{1}{N}} .$$

where

$$= \frac{1}{2} ( {n}_{0} + N ) ,$$

[symbol]

represents the candidate sample number of the i^{th} feature sent to the participant j.

$$( f ) p = \frac{1}{K} {\sum }_{k = 1}^{K} 1 [ {E}_{x ∈ D} ( 1 [ {M}_{i , j} ( x ; {θ}_{i , j , , k} ) \neq {M}_{i , j} ( x ; {θ}_{i , j , N , k} ) ] ) < ϵ ]$$

is calculated, where

$$M ( x ; {θ}_{i , j , , k} )$$

represents that the participant j takes the feature data held by the sample X as the input,

$${θ}_{i , j , , k}$$

is a model parameter. The output of the model M_{i,j} is a predicted feature data I. D is a sample set, E(*) is an excepted value. ∈ is a real number that represents a threshold, such as 0.1 and 0.01, which is selected according to the required model precision (1−∈).

If p>1−δ, letting

$$= \frac{1}{2} ( {n}_{i , j , 0} + ) ,$$

and if p<1−δ, letting

$$= \frac{1}{2} ( N + ) ,$$

where δ represents a threshold, which is a real number, and is generally 0.05. Carrying out the process according to the step (e) and the step (f) for mutiple times until the optimal candidate sample number [symbol] that should be selected for each feature is obtained through convergence.
(g) The size of the obtained [symbol] is sent to the original participants. The number of samples randomly selected by the each participant to a participant j of feature i is [symbol] . Each participant determines the optimal sample number of each selected feature to be sent to each participant according to the above steps, and selects samples.
(2) Noise satisfying differential privacy is added to the data selected in the step (1) by all participants, and the data with the added noise and the data indexes are sent to the other participants.
(3) After receiving all the data, all participants align the data according to the data indexes, take the feature data originally held in the same data index as input, and take the received feature data as labels to train multiple models, respectively. In an embodiment, take the features owned by all participants as a set, and all participants take each missing feature as a learning task. Then, the feature data received in step (2) is used as the labels for learning tasks, and the existing data is used as the input to train multiple models and predict the missing features.

For the features which do not receive the data, the labeled-unlabled multitask learning method is used to learn the model of the task. In the case of one participant, for example, the process includes the following steps:
(a) The participant divides the existing data thereof into m data sets S, corresponding to the training data of each missing feature, respectively. m is the number of the missing features. I is the feature number of labeled tasks in the missing features.
(b) A difference between the data sets is calculated according to the training data: disc (Sₚ, S_{q}), p, q∈{1, . . . , m}, p≠q, disc (Sₚ, Sₚ)=0. (c) For each unlabeled task,

$$\frac{1}{m} {\sum }_{q = 1}^{m} {\sum }_{p ∈ I} {σ}_{p} disc ( {S}_{q} , {S}_{p} )$$

is minimized, a weight σ^{T}={σ₁, . . . , σₘ} is obtained, where Σₚ₌₁^{m} σₚ=1, and I is a set of labeled tasks.
(d) A model M_{T} of each unlabeled task can be obtained by minimizing the convex combination of training errors of labeled tasks, where T∈{1, . . . , m}/I:

$${{σ}^{T}}_{} ( {M}_{T} ) = {\sum }_{p ∈ I} {σ}_{p} {p}_{} ( {M}_{T} )$$

$$where {p}_{} ( {M}_{T} ) = \frac{1}{{n}_{{s}_{p}}} {\sum }_{( x , y ) ∈ {S}_{p} , p ∈ I} L ( {M}_{T} ( x ) , y ) .$$

L(*) is a loss function of a model in which a sample of a data set Sₚ is taken as the input. nₛ_{ₚ} represents a sample number of a data set Sₚ. x is a sample feature of the input. y is a label.
(4) All participants use the model corresponding to each task obtained by training to predict the data corresponding to other data indexes to complete the missing feature data.
(5) All participants work together by horizontal federated learning method to obtain a final trained model. The horizontal federated learning method is not limited to a specific method.

In order to make the purpose, the technical solution and the advantages of the present disclosure more clear, the technical solution of the present disclosure will be described clearly and completely in combination with an embodiment below. It is obvious that the embodiment described is only some but not all embodiments of the present disclosure. Based on the embodiments in the present disclosure, all other embodiments obtained by those skilled in the art without any creative effort fall within the protection scope of the present disclosure.

### Embodiment

A and B represent a bank and an e-commerce company respectively, and are both desired to jointly train a model to predict the economic level of users by the federated learning method according to the present disclosure. Due to the differences in business between the bank and the e-commerce company, they hold different features in training data, so it is feasible for them to work together to train a model with higher accuracy and stronger generalization performance. A and B hold data (X_{A}, Y_{A}) and (X_{B}, Y_{B}), respectively.

$${X}_{A} = [ \begin{matrix}{x}_{A , 1} \\ ⋯ \\ {x}_{A , N}\end{matrix} ]$$

$$and$$

$${X}_{B} = [ \begin{matrix}{x}_{B , 1} \\ ⋯ \\ {x}_{B , N}\end{matrix} ]$$

are training data,

$${Y}_{A} = [ \begin{matrix}{Y}_{A , 1} \\ ⋯ \\ {Y}_{A , N}\end{matrix} ]$$

$$and$$

$${Y}_{B} = [ \begin{matrix}{Y}_{B , 1} \\ ⋯ \\ {Y}_{B , N}\end{matrix} ]$$

are labels corresponding to the training data, where N represents the size of the data volume. The training data of A and B include the same user samples, but each sample has different features. The feature numbers of A and B are represented by m_{A} and m_{B}, respectively, namely

$${x}_{A , i} = [ {x}_{A , i}^{1} , {x}_{A , i}^{2} , … , {x}_{A , i}^{{m}_{A}} ] ,$$

$${x}_{B , i} = [ {x}_{B , i}^{1} , {x}_{B , i}^{2} , … , {x}_{B , i}^{{m}_{B}} ] .$$

Due to user privacy issue and other reasons, A and B cannot share data with each other, so the data is stored locally. In order to solve the problem, the bank and the e-commerce company can jointly train a model by using vertical federated learning as follows.

Step S101, the bank A and the e-commerce company B randomly selected part of features of the data feature set held and a small number of samples of the selected features.

In an embodiment, the bank A and the e-commerce company B randomly selected r_{A} features and r_{B} features from m_{A} features and m_{B} features thereof, respectively. For each selected feature, A and B randomly selected nᵢ_{_{A}}_{,B} samples and nᵢ_{_{B}}_{,A} samples, respectively, where i_{A}=1 . . . r_{A}, i_{B}=1 . . . r_{B}.

Step S1011, for each feature, the bank A and the e-commerce company B use the BlinkML method to determine the sample number, which can reduce the data transmission while ensuring the training accuracy of the feature model.

In an embodiment, A sent some samples of the feature i_{A} to B, for example. A randomly selected n₀ samples and sends them to B, where n₀ is very small, and B calculated

$$= \frac{1}{2} ( {n}_{0} + N ) ,$$

used a feature i_{A} of the n₀ samples received as labels to train a model θᵢ_{_{A}}_{,B}. A matrix Q was constructed with no samples and θᵢ_{_{A}}_{,B}, where each row of Q represents a gradient obtained by updating θᵢ_{_{A}}_{,B} of each sample. Matrix decomposition Q^{T}=UΣV^{T} was used to obtain Σ, and a diagonal matrix Λ was constructed, where the value of the r^{th} element is sᵣ/(sᵣ²+β), sᵣ is the r^{th} singular value in Σ, β is a regularization coefficient, which can be 0.001. L=UA was calculated. The following process for K times was repeated to obtain K pairs

$$( {θ}_{i , j ,} , {θ}_{i , j , N , k} ) .$$

a) Obtaining

$${θ}_{{i}_{A} , B ,} {,}_{k}$$

by sampling from a normal distribution

$$N ( {θ}_{{i}_{A} , B ,} {α}_{1} L {L}^{T} ) ,$$

where

$${α}_{1} = \sqrt{\frac{1}{{n}_{0}} - \frac{1}{, {,}_{0}}} .$$

b) Obtaining θᵢ_{_{A}}_{,B,N,k} by sampling from a normal distribution

$$N ( {θ}_{{i}_{A} , B , {,}_{0} , k} , {α}_{2} {LL}^{T} ) ,$$

$$where$$

$${α}_{1} = \sqrt{\frac{1}{, {,}_{0}} - \frac{1}{n}} .$$

$$p = \frac{1}{k} {Σ}_{i = 1}^{k} 1 [ {E}_{x ∈ D} ( 1 [ M ( x ; {θ}_{{i}_{A} , B ,} {,}_{0 , k} ) \neq M ( x ; {θ}_{{i}_{A} , B , N , k} ) ] ) < ϵ ]$$

was calculated. If p>1−δ,

$$= \frac{1}{2} ( {n}_{0} + ) ,$$

and if

$$p < 1 - δ , = \frac{1}{2} ( N + ) .$$

The previous process and this process were repeated. It should be noted that the process is actually a binary search process, which is used to find the optimal ñ. Then, B sent the size of ñ, to A. Similarly, the process can also be used to determine the minimum count of the samples sent by B to A.

Step S1011, A and B added noise satisfying differential privacy to the selected data, respectively, and sent the data with noise added and data indexes to each other. The data indexes can ensure data alignment in subsequent stages. In the scene of vertical federated learning, the indexes do not disclosure additional information.

Step S102, A and B took the prediction of each missing feature as a learning task, respectively, and took the received feature data as labels to train multiple models respectively. At the same time, for features without data, A and B trained the model by labeled-unlabled multitask learning method.

In an embodiment, A sent part of samples to B, for example.
(a) B divided the existing data thereof into m_{A} data sets, corresponding to the training data of each feature respectively, where m_{A} is the number of the missing features, and also the number of features owned by A in the embodiment.
(b) A difference between the data sets is calculated according to the training data: disc(Sₚ,S_{q}), p, q∈{1, . . . , m_{A}}, p≠q, disc(Sₚ,Sₚ)=0.
(c) Assuming I was a set of labeled tasks, I∈{1, . . . , m_{A}}, |I|=r_{A}, for each unlabeled task,

$$\frac{1}{{m}_{A}} {Σ}_{q = 1}^{{m}_{A}} {Σ}_{p ∈ I} {σ}_{p} d i s c ( {S}_{q} , {S}_{p} )$$

was minimized and a weight σ^{T}={σ₁, . . . , σₘ_{_{A}}} was obtained, where

$${Σ}_{p = 1}^{{m}_{A}} {σ}_{p} = 1 .$$

(d) For labeled tasks, the received labels could be directly trained to obtain the corresponding model.
(e) For each unlabeled task, the model of the unlabeled task M^{T} could be obtained by minimizing a convex combination of training errors of labeled tasks, where T∈{1, . . . , m_{A}}/I:

$${{σ}^{T}}_{} ( {M}_{T} ) = {Σ}_{p ∈ I} {σ}_{p} {p}_{} ( {M}_{T} )$$

$$where$$

$${p}_{} ( {M}_{T} ) = \frac{1}{{n}_{{s}_{p}}} {Σ}_{( x , y ) ∈ {S}_{{pS}_{p ,} p ∈ I}} L ( {M}_{T} ( x ) , y ) .$$

L(*) is a loss function of the model in which the sample of the data set Sₚ is taken as the input. nₛ_{ₚ} represents the sample number of the data set Sₚ. x is a sample feature of the input. y is a label of data set Sₚ during training task.

Step S103, A and B predict the data of other samples with the trained model, respectively, to complete the missing feature data.

Step S104, A and B carried out the training together with horizontal federated learning method to obtain a final trained model.

The efficient, secure and low-communication vertical federated learning method according to the present disclosure can use the data held by each participant to jointly train the model without exposing the local data of the participants by combining with horizontal federated learning. The privacy protection level of the method satisfies differential privacy, and the training result of the model is close to centralized learning.

The steps of the method or algorithm described combined with the embodiments of the present disclosure may be implemented in a hardware manner, or may be implemented in a manner in which a processor executes software instructions. The software instructions may consist of corresponding software modules, and the software modules can be stored in Random Access Memory (RAM), flash memory, Read Only Memory (ROM), Erasable Programmable ROM (EPROM), Electrically Erasable Programmable Read-Only Memory (EEPROM), registers, hard disks, removable hard disks, CD-ROMs or any other forms of storage media well-known in the art. An exemplary storage medium is coupled to the processor, such that the processor can read information from, and write information to, the storage medium. The storage medium can also be an integral part of the processor. The processor and storage medium may reside in an Application Specific Integrated Circuit (ASIC). Alternatively, the ASIC may be located in a node device, such as the processing node described above. In addition, the processor and storage medium may also exist in the node device as discrete components.

It should be noted that when the data compression apparatus provided in the foregoing embodiment performs data compression, division into the foregoing functional modules is used only as an example for description. In an actual application, the foregoing functions can be allocated to and implemented by different functional modules based on a requirement, that is, an inner structure of the apparatus is divided into different functional modules, to implement all or some of the functions described above. For details about a specific implementation process, refer to the method embodiment. Details are not described herein again.

All or some of the foregoing embodiments may be implemented by using software, hardware, firmware, or any combination thereof. When the software is used for implementation, all or some of the embodiments may be implemented in a form of a computer program product. The computer program product includes one or more computer instructions. When the computer program instructions are loaded and executed on a server or a terminal, all or some of the procedures or functions according to the embodiments of this application are generated. The computer instructions may be stored in a computer-readable storage medium or may be transmitted from a computer-readable storage medium to another computer-readable storage medium. For example, the computer instructions may be transmitted from a web site, computer, server, or data center to another web site, computer, server, or data center in a wired (for example, a coaxial optical cable, an optical fiber, or a digital subscriber line) or wireless (for example, infrared, radio, or microwave) manner. The computer-readable storage medium may be any usable medium accessible by a server or a terminal, or a data storage device, such as a server or a data center, integrating one or more usable media. The usable medium may be a magnetic medium (for example, a floppy disk, a hard disk, or a magnetic tape), an optical medium (for example, a digital video disk (DVD)), or a semiconductor medium (for example, a solid-state drive).

The above is only preferred embodiments of the present disclosure and is not used to limit the present disclosure. Any amendment, equivalent replacement and improvement made under the spirit and principle of the present disclosure shall fall within the protection scope of the present disclosure.

What is claimed is:

1. An efficient, secure and low-communication vertical federated learning method, comprising:
step (1) selecting, by all participants, part of features of a held data feature set, adding noise satisfying differential privacy to part samples of the selected features and send the selected part of features to other participants together with data indexes of the selected samples, wherein the held data feature set comprises feature data and label data;
step (2) aligning, by all participants, data according to data indexes, taking received feature data as a label, taking each missing feature as a learning task, and training a model for each task with feature data originally held in a same data index;
step (3) predicting, by all participants, data corresponding to other data indexes with multiple models trained in the step (2) to complete missing feature data; and
step (4) obtaining, by all participants, a final trained model by jointly using horizontal federated learning method.

2. The efficient, secure and low-communication vertical federated learning method according to claim 1, wherein when all participants hold label data, the held data feature set only consists of feature data.

3. The efficient, secure and low-communication vertical federated learning method according to claim 1, wherein in the step (1), the data feature set is personal privacy information.

4. The efficient, secure and low-communication vertical federated learning method according to claim 1, wherein in the step (1), each participant uses BlinkML method to determine an optimal sample number of each selected feature sent to each of the other participants, and then adds noise satisfying differential privacy to part of the samples of each selected feature according to the determined optimal sample number, and sends the part of the samples to other corresponding participants together with the data indexes of the selected samples.

5. The efficient, secure and low-communication vertical federated learning method according to claim 3, wherein each participant uses the BlinkML method to determine an optimal sample number of each selected feature sent to each of the other participants, comprising:
(a) selecting, by each participant uniformly and randomly, no sample data for each selected feature i, adding differential privacy noise to the no sample data, and then sending the no sample data to other participants together with the data indexes of the selected samples;
(b) aligning, by a participant j receiving the data, the data according to the data indexes, and taking the received feature data i as a label, and training and obtaining a model M_{i,j} by using feature data originally held in the same data index;
(c) constructing a matrix Q, wherein each row of Q comprises n₀ parameter gradients obtained by updating a model parameter θ_{i,j} of M_{i,j} of each sample;
(d) calculating L=UA, wherein U is a matrix of size n₀×n₀ after singular value decomposition of the matrix Q; Λ is a diagonal matrix, the value of the r^{th} element on the diagonal of the matrix Λ is sᵣ/(sᵣ²+β), sᵣ is the r^{th} singular value in Σ, β is a regularization coefficient; and Σ is a singular value matrix of matrix Q;
(e) obtaining
$${θ}_{i , j ,}$$
by sampling from a normal distribution
$$N ( {θ}_{i , j} , {α}_{1} L {L}^{T} ) ,$$
and then obtaining θ_{i,j,N,k} by sampling from a normal distribution
$$N ( {θ}_{i , j , , k} , {α}_{2} L {L}^{T} ) ,$$
repeating K times to obtain K pairs
$$( {θ}_{i , j , , k} , {θ}_{i , j , N , k} ) ,$$
where k represents sampling sample number;
wherein
$${α}_{1} = \sqrt{\frac{1}{{n}_{0}} - \frac{1}{}} ,$$
$${α}_{2} = \sqrt{\frac{1}{} - \frac{1}{N}} ,$$
$$= \frac{1}{2} ( {n}_{0} + N ) ,$$
represents a candidate sample number of an i^{th} feature sent to the participant j; and N is a total number of samples for each participant;
(f) calculating
$$p = \frac{1}{K} {Σ}_{k = 1}^{K} 1 [ {E}_{x ∈ D} ( 1 [ {M}_{i , j} ( x ; {θ}_{i , j , k} ) \neq {M}_{i , j} ( x ; {θ}_{i , j , N , k} ) ] ) < ϵ ] ;$$
where
$$M ( x ; {θ}_{i , j , k} )$$
represents mat me participant j takes feature data held by a sample x as an input;
$${θ}_{i , j , k}$$
is a model parameter; an output of the model M_{i,j} is a predicted feature data i; D is a sample set, E(*) is an excepted value; and ∈ is a real number that represents a threshold;
if p>1−δ, letting
$$= \frac{1}{2} ( {n}_{i , j , 0} + ) ,$$
and if p<1−δ, letting
$$= \frac{1}{2} ( N + ) ;$$
δ represents a threshold, which is a real number; carrying out the process according to the step (e) and the step (f) for multiple times until an optimal candidate sample number [symbol] that is to be selected for each feature is obtained through convergence; and
(g) a number of samples randomly selected by the each participant to participant j of feature i being [symbol] .

6. The efficient, secure and low-communication vertical federated learning method according to claim 1, wherein in the step (2), when each participant has a missing feature which does not receive the data, using labeled—unlabeled multitask learning method to obtain a model of the missing feature with unreceived data, comprising:
(a) dividing, by a participant, existing data of the participant into m data sets S which correspond to training data of each missing feature, respectively, wherein m is a number of missing features of the participant, and I is a set of labeled tasks in the missing features;
(b) calculating a difference between the data sets according to the training data: disc (Sₚ, S_{q}), p, q∈{1, . . . , m}, p≠q, disc (Sₚ, Sₚ)=0;
(c) minimizing, for each unlabeled task,
$$\frac{1}{m} {Σ}_{q = 1}^{m} {Σ}_{p ∈ I} {σ}_{p} disc ( {S}_{q} , {S}_{p} )$$
and obtaining a weight σ^{T}={σ₁, . . . , σₘ}, where Σₚ₌₁^{m} σₚ=1; and
(d) a model M_{T} of each unlabeled task is obtained by minimizing a convex combination of training errors of labeled tasks, where T∈{1, . . . , m}/l;
$${\hat{e r}}_{{σ}^{T}} ( {M}_{T} ) = {\sum }_{p ∈ I} {σ}_{p} ( {M}_{T} ) ,$$
where
$$( {M}_{T} ) = \frac{1}{{n}_{{S}_{p}}} {Σ}_{( x , y ) ∈ {S}_{p} , p ∈ I} L ( {M}_{T} ( x ) , y ) ;$$
where L(*) is a loss function of a model in which a sample of a data set Sₚ is taken as an input; nₛ_{ₚ} represents a sample number of a data set Sₚ; x is a sample feature of the input; and y is a label.
